(19) United States
(12) Patent Application Publication
(10) Pub. No.: US 2026/0003249 A1
(43) Pub. Date: Jan. 1, 2026

(54) CAMERA APPARATUS AND LIGHT FILLING METHOD THEREFOR

(71) Applicant: GUANGZHOU LUXVISIONS INNOVATION TECHNOLOGY LIMITED, Guangzhou City (CN)

(72) Inventors: Guan-Yang Liu, Guangzhou City (CN); Yi-Wei Liu, Guangzhou City (CN)

(73) Assignee: GUANGZHOU LUXVISIONS INNOVATION TECHNOLOGY LIMITED, Guangzhou City (CN)

(21) Appl. No.: 19/028,021

(22) Filed: Jan. 17, 2025

(30) Foreign Application Priority Data
Jun. 26, 2024 (CN) 202410842099.3

(51) Int. Cl. G03B 15/03; H05B 47/11; H05B 47/115

(52) U.S. Cl. CPC G03B 15/03; H05B 47/11; H05B 47/115

(57) ABSTRACT

A camera apparatus and a light filling method therefor are provided. The camera apparatus includes an array light source element, an optical lens assembly, a detection unit, a control unit, a camera unit, and a computing unit. The array light source element includes a plurality of light-emitting units. The optical lens assembly is located on a light exit side of the array light source element. The detection unit detects a scene depth profile for the scene. The scene depth profile is divided into a plurality of depth blocks, and the depth blocks are in a one-to-one correspondence with the light-emitting units. The computing unit drives, based on the scene depth profile or a camera mode, the control unit to selectively perform a lighting-up operation on each of the light-emitting units, and controls the camera unit to capture an image of the scene.

### CROSS-REFERENCE TO RELATED APPLICATION

This non-provisional application claims priority under 35 U.S.C. § 119(a) to patent application No. 202410842099.3 filed in China on Jun. 26, 2024, the entire contents of which are hereby incorporated by reference.

### BACKGROUND

### Technical Field

The present invention relates to a photography light filling technology, specifically to a camera apparatus having an array light source element and a light filling method therefor.

### Related Art

At present, mobile devices generally use two types of flashes. One is a xenon flash, and the other is a light-emitting diode (LED) flash. The xenon flash needs specific charging time to emit a flash, which affects continuous shooting and cannot be always on for use. Although the LED flash can be always on and has a fast enough flicker speed, the LED flash is a single light source and can only fill light for a scene in a large range. In this way, regions that do not need light filling are also illuminated, resulting in energy waste. Additionally, for regions that do require light filling, the photographed target may appear flat due to over-lighting, causing it to lose its sense of depth.

### SUMMARY

According to an embodiment of the present invention, a camera apparatus includes an array light source element, an optical lens assembly, a detection unit, a control unit, a camera unit, and a computing unit. The array light source element includes a plurality of light-emitting units distributed in a two-dimensional array. The optical lens assembly is located on the light exit side of the array light source element, to project, to a scene, light beams respectively emitted by the light-emitting units. The detection unit includes a depth sensing element, to detect a scene depth profile for the scene. The scene depth profile is divided into a plurality of depth blocks, and the depth blocks are in a one-to-one correspondence with the light-emitting units. The control unit is coupled to the array light source elements to control a lighting-up operation of each light-emitting unit. The lighting-up operation includes brightness and lighting-up time. The camera unit is configured to capture an image of the scene in a camera mode. The computing unit is coupled to the detection unit, the control unit, and the camera unit, and drives the control unit to selectively control the lighting-up operation on each of the light-emitting units based on the scene depth profile or the camera mode.

According to an embodiment of the present invention, a light filling method for a camera apparatus includes: detecting a scene depth profile and an ambient light intensity for a scene by a detection unit; determining whether the camera apparatus operates in an automatic photographing or a manual photographing state; in the automatic photographing state, when recognizing that the scene needs light filling based on a signal fed back by the detection unit, a computing unit determines the camera mode of the camera unit and a lighting-up operation of an array light source element; and in the manual photographing state, the computing unit determines the lighting-up operation of the array light source element based on a selected camera mode.

According to the camera apparatus and the light filling method therefor in some embodiments of the present invention, based on the array light source element, beam deformation can be controlled in a pixilated manner, to appropriately fill light for an object being photographed in various camera modes, thereby improving the efficiency of light filling.

### BRIEF DESCRIPTION OF THE DRAWINGS

FIG. 1 is a schematic architectural diagram of a camera apparatus according to an embodiment of the present invention;

FIG. 2 is a diagram of a mapping relationship between a scene depth profile and an array light source element;

FIG. 3 is a schematic structural diagram of an array light source element and an optical lens assembly according to an embodiment of the present invention;

FIG. 4 is a schematic diagram of light filling in a telephoto mode according to an embodiment of the present invention;

FIG. 5 is a schematic diagram of light filling in a portrait mode according to an embodiment of the present invention;

FIG. 6 is a schematic diagram of light filling in a portrait mode according to another embodiment of the present invention;

FIG. 7 is a schematic diagram of light filling in a wide-angle mode according to an embodiment of the present invention;

FIG. 8 is a schematic diagram of light filling in a dynamic mode according to an embodiment of the present invention;

FIG. 9 is a flowchart of a light filling method for a camera apparatus according to an embodiment of the present invention;

FIG. 10 is a flowchart of the operation of a camera apparatus in an automatic photographing state according to an embodiment of the present invention; and

FIG. 11 is a flowchart of the operation of a camera apparatus in a manual photographing state according to an embodiment of the present invention.

### DETAILED DESCRIPTION

The following describes the present invention in detail with reference to the accompanying drawings and specific embodiments, but it should not be used as a limitation on the present invention.

“Coupling” used in this specification refers to that two or more elements are in physical or electrical contact with each other “directly”, or are in physical or electrical contact with each other “indirectly”, so that coupled elements can interact, such as communicate or control, with each other.

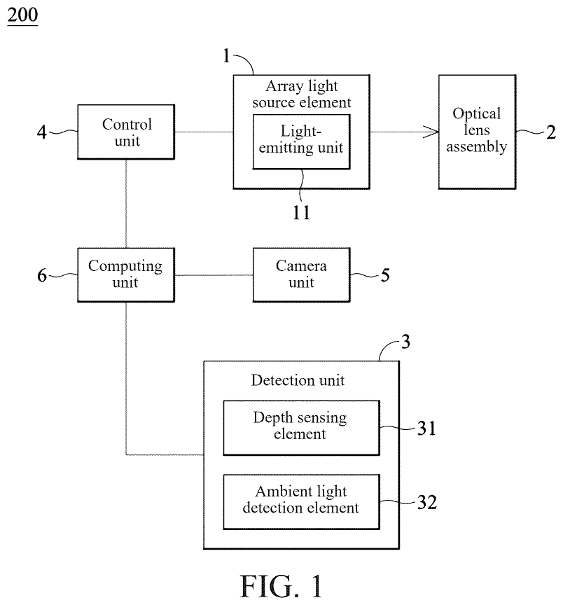

FIG. 1 is a schematic architectural diagram of a camera apparatus 200 according to an embodiment of the present invention. The camera apparatus 200 includes an array light source element 1, an optical lens assembly 2, a detection unit 3, a control unit 4, a camera unit 5, and a computing unit 6. The camera apparatus 200 may be, for example, an electronic apparatus having a camera function such as a camera, a mobile phone, or a tablet computer.

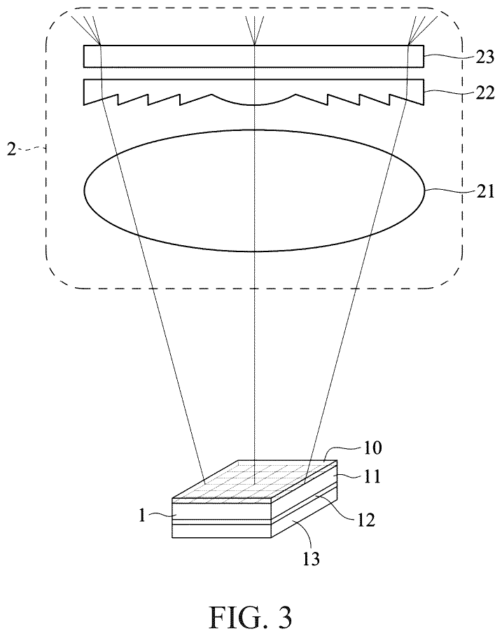

The array light source element 1 includes a plurality of light-emitting units 11 distributed in a two-dimensional array (as shown in FIG. 3). The light-emitting units 11 are independent light-emitting sources that can be individually controlled to emit light. The optical lens assembly 2 is located on the light exit side of the array light source element 1, to project, to a scene, light beams respectively emitted by the light-emitting units 11. The light emitted by each of the light-emitting units 11 is projected to a unique position in the scene. These projection positions are determined based on the arrangement of the light-emitting units 11 in the two-dimensional array. Specifically, a position of each of the light-emitting units 11 corresponds to a unique position in the scene. Therefore, when each of the light-emitting units 11 in the array light source element 1 emits light, the light-emitting units 11 can jointly illuminate an entire scene. When some of the light-emitting units 11 in the array light source element 1 emit light and some of the light-emitting units 11 do not emit light, a specific light pattern is formed to be projected into the scene.

The control unit 4 is coupled to the array light source element 1 to control a lighting-up operation of each of the light-emitting units 11. The lighting-up operation of each light-emitting unit 11 controlled by the control unit 4 includes brightness and lighting-up time. To be specific, the control unit 4 may control light-emitting parameters such as brightness and lighting-up time (that is, a lighting-up period, including the lighting-up start time and the lighting-up end time) of each of the light-emitting units 11.

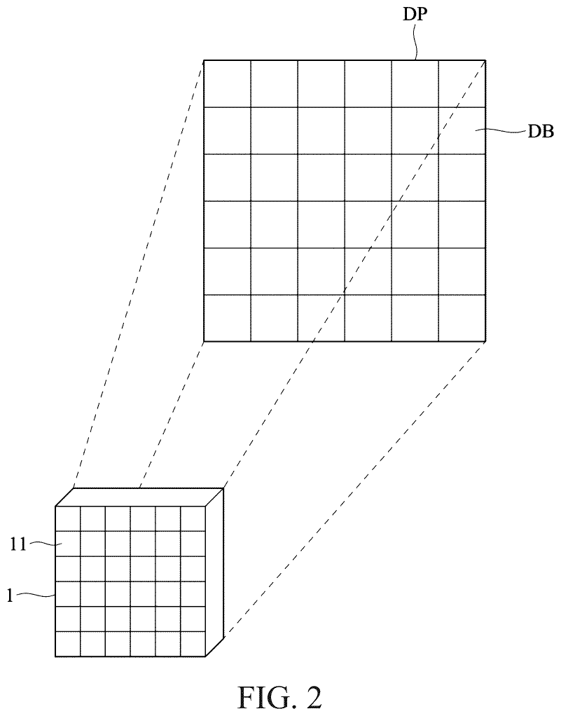

The detection unit 3 includes a depth sensing element 31. The depth sensing element 31 detects a scene depth profile DP for the same scene. FIG. 2 is a diagram of a mapping relationship between a scene depth profile DP and the array light source element 1. The scene depth profile DP is a three-dimensional depth image, and is divided into a plurality of depth blocks DBs distributed in a two-dimensional array. Each depth block DB corresponds to a unique position in the scene based on the arrangement of the depth block DB distributed in the two-dimensional array. Each depth block DB has depth information corresponding to a position in the scene. Because both the light-emitting units 11 and the depth blocks DBs correspond to corresponding unique positions in the scene based on the arrangement positions of the light-emitting units 11 and the arrangement positions of the depth blocks DBs, the depth blocks DBs and the light-emitting units 11 have a mapping relationship based on the depth blocks DBs and the light-emitting units 11 distribution in the two-dimensional array, so that the depth blocks DBs are in a one-to-one correspondence with the light-emitting units 11. For example, a depth block DB in a first row and a first column corresponds to a light-emitting unit 11 in a first row and a first column, and a depth block DB in the first row and a second column corresponds to a light-emitting unit 11 in the first row and the second column, and so on. In some embodiments, the depth sensing element 31 detects the scene depth profile DP based on a distance detection technology such as electromagnetics (for example, microwave), acoustics (for example, ultrasonic), or optics (for example, infrared light).

The camera unit 5 captures an image of the scene in a camera mode. In other words, the array light source element 1, the depth sensing element 31, and the camera unit 5 respectively project light beams to the same scene, and detect a depth and capture an image of the same scene. A range of the scene is consistent with a field of view (FOV) of at least one focal length of the camera unit 5.

The computing unit 6 is coupled to the detection unit 3, the control unit 4, and the camera unit 5. The computing unit 6 drives, based on the scene depth profile DP or the camera mode, the control unit 4 to selectively perform the lighting-up operation on each of the light-emitting units 11, to determine light filling requirements such as a shape, brightness, and lighting-up time of a light pattern, to capture the image in cooperation with the camera unit 5.

FIG. 3 is a schematic structural diagram of an array light source element 1 and an optical lens assembly 2 according to an embodiment of the present invention. The array light source element 1 includes a light-transmitting protective layer 10, a plurality of light-emitting units 11, an electrode 12, and a circuit substrate 13 that are sequentially stacked. The circuit substrate 13 has a circuit layout to drive the electrode 12 to control a corresponding light-emitting unit 11 to emit light. In some embodiments, the light-emitting units 11 are micro light-emitting diodes (μLEDs). The light-transmitting protective layer 10 provides protection and has a light-transmitting effect, so that light emitted by the light-emitting units 11 can pass through. In some embodiments, the light-transmitting protective layer 10 is made of a material such as glass or a polymer.

The optical lens assembly 2 is configured to shape light beams emitted by the array light source element 1, so that output light efficiency can be maximized. The optical lens assembly 2 includes a convex lens 21, a Fresnel lens 22, and a scattering layer 23. A light-receiving range of the convex lens 21 covers divergence angles of the light beams respectively emitted by the light-emitting units 11, so that each of the light beams is expanded through the convex lens 21. The convex lens 21 is located between the Fresnel lens 22 and the array light source element 1, to cause each of the light beams expanded to be collimated and outputted through the Fresnel lens 22. An output direction is an orientation corresponding to a corresponding depth block DB in the scene. The Fresnel lens 22 has a periodic zigzag structure with a specific curvature on a side close to the convex lens 21, to achieve beam collimation. The Fresnel lens 22 may be manufactured and molded by injection molding or molding. The scattering layer 23 is located on an outermost side, that is, the Fresnel lens 22 is located between the scattering layer 23 and the convex lens 21. Through the scattering layer 23, light homogenization processing may be performed on the collimated light beams to achieve an effect of improving a divergence angle of a light exit surface. In some embodiments, the scattering layer 23 includes a plurality of scattering particles of different particle sizes or an aperiodic microstructure, so that light enters the scattering layer 23 and is scattered by an internal structure of the scattering layer 23. Therefore, a cross-sectional area of each of the light beams after passing through the scattering layer 23 is greater than a cross-sectional area of each of the light beams before passing through the scattering layer 23.

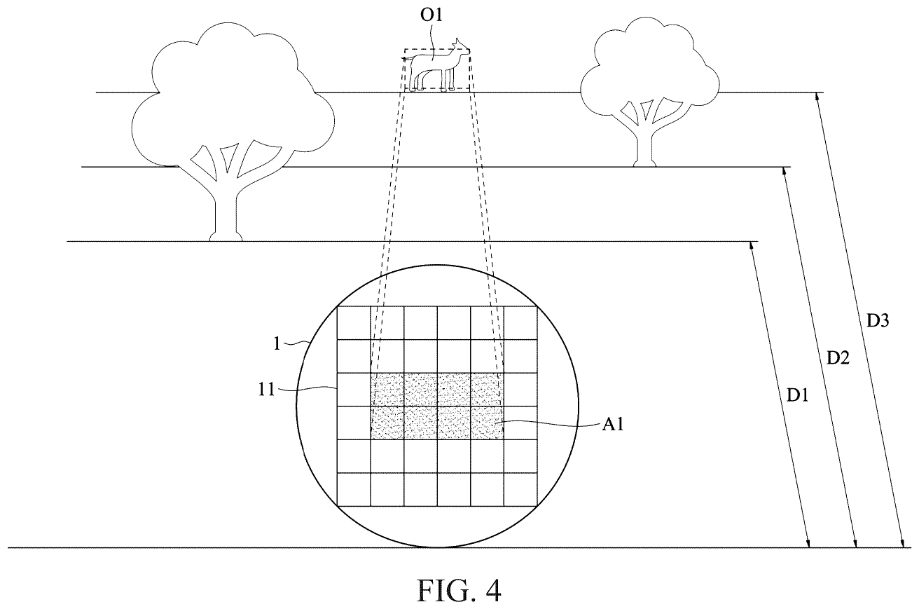

Lighting-up operations in various camera modes are described below. FIG. 4 is a schematic diagram of light filling in a telephoto mode according to an embodiment of the present invention. In the telephoto mode, the computing unit 6 calculates a required light filling brightness, range, and light filling duration based on a distance D3 from a focus target (a long-shot object O1), to control the control unit 4 to supply a current to the light-emitting units 11 corresponding to a light-emitting region A1 of the array light source element 1. A magnitude of the supplied current is positively correlated with the required brightness. The distance D3 is obtained based on the scene depth profile DP. Specifically, depth information of a focus point is obtained at a corresponding position in the scene depth profile DP based on a position of the focus point in the field of view of the camera unit 5, and the distance D3 is obtained based on the depth information. The intensity of the light filling brightness is positively correlated with the distance D3. In other words, a longer distance D3 indicates that the intensity of the light-filling brightness is greater. Based on the position of the focus point, not only a depth block DB corresponding to the scene depth profile DP but also other depth blocks DBs adjacent to the depth block DB and having the same or similar depth information may be found in the scene depth profile DP. These depth blocks DBs having the same or similar depth information as the focus point may be considered as long-shot object blocks corresponding to the long-shot object O1. In other words, some of the depth blocks DBs extracted from the scene depth profile DP are identified as long-shot object blocks, and these long-shot object blocks correspond to the long-shot object O1 in the scene. Based on the mapping relationship between the depth block DB and the light-emitting units 11 shown in FIG. 2, the light-emitting units 11 corresponding to the long-shot object block may be found in the array light source element 1. In FIG. 4, the region covered by these light-emitting units 11 corresponding to the long-shot object block is the light-emitting region A1, and therefore the lighting-up operation is performed. Accordingly, the light beams emitted by the light-emitting region A1 fills light toward the long-shot object O1. Furthermore, because other light-emitting units 11 do not perform the lighting-up operation, it will not fill the light for other non-target objects (for example, target objects at distance D1 and distance D2), the light source is effectively applied where light filling is required.

In some embodiments, depending on the brightness of ambient light, other light-emitting units 11 not belonging to the light-emitting region A1 may also emit light with proper brightness to make up for insufficient brightness of the ambient light. The light with proper brightness is calculated based on the brightness of ambient light and the depth information (for example, the distance D1 and the distance D2) of the corresponding depth block DB.

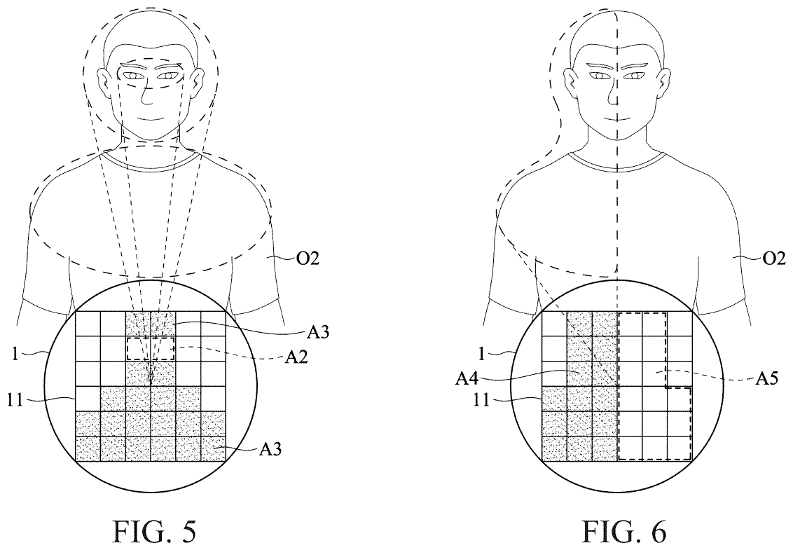

FIG. 5 is a schematic diagram of light filling in a portrait mode according to an embodiment of the present invention. In the portrait mode, to resolve a problem of backlight photographing, a specific region shadow can be filled by filling light for the target (character O2). In this way, the colors in the foreground can be highlighted, so that an image of the character is more prominent. To avoid a phenomenon that a light filling beam irradiates human eyes and causes an iris to reflect and generate red light, the computing unit 6 performs image identification in an instant preview mode of the camera unit 5 to identify a position of the eyes, to control the camera unit 5 to focus on the position of the eyes, then divisionally lights up the light-emitting units 11 that are in the array light source element 1 and that project on the character O2 other than the human eyes, and actively controls the camera unit 5 to capture the image. The position of the eyes may be identified through an image manner, for example, by detecting facial and/or eye features with conventional image processing and computer vision technologies, or by estimating the position of the eyes via machine learning.

Referring to FIG. 2 and FIG. 5 together, depth blocks DB corresponding to the position of eyes and other depth blocks DBs that are adjacent to the depth blocks DB and have the same or similar depth information may be found in the scene depth profile DP. These depth blocks DBs having the same or similar depth information as the focus point may be considered as human body blocks corresponding to the character O2. In other words, some of the depth blocks DBs extracted from the scene depth profile DP are identified as human body blocks, and these human body blocks correspond to the character O2 in the scene. The human body blocks include a first part and a second part. The first part corresponds to eyes of the character O2, and the second part corresponds to remaining parts of the character O2. Based on the mapping relationship between the depth blocks DB and the light-emitting units 11 shown in FIG. 2, the light-emitting units 11 corresponding to the human body blocks may be found in the array light source element 1. The light-emitting units 11 include light-emitting units 11 corresponding to an eye part (the first part) and light-emitting units 11 corresponding to a remaining part (the second part) of the character O2. The light-emitting units 11 (that is, a non-light-emitting region A2) corresponding to the eye part (the first part) does not perform the lighting-up operation, and the light-emitting units 11 corresponding to the remaining part (the second part) of the character O2 (that is, a light-emitting region A3) performs the lighting-up operation. Therefore, light filling may be performed on the foreground character O2, and the light is prevented from irradiating eyes of the character O2.

FIG. 6 is a schematic diagram of light filling in a portrait mode according to another embodiment of the present invention. In the portrait mode, to highlight a portrait outline, the array light source element 1 emits light in regions to generate light beams that is biased toward a side of the character O2. As described above, after the human body blocks corresponding to the character O2 are found in the scene depth profile DP, the computing unit 6 distinguishes the human body blocks into two parts. Herein, the human body blocks are divided into left and right parts based on a longitudinal axis of a human body, but the present invention is not limited to this division manner. The first part corresponds to a first side of the character O2, and the second part corresponds to a second side of the character O2. A description is provided herein by using a right half of the character O2 as the first side and a left half of the character O2 as the second side. Based on the mapping relationship between the depth blocks DB and the light-emitting units 11 shown in FIG. 2, the light-emitting units 11 corresponding to the human body blocks may be found in the array light source element 1. The light-emitting units 11 include light-emitting units 11 corresponding to the right half (the first part) of the character O2 and light-emitting units 11 corresponding to the left half (the second part) of the character O2. The light-emitting units 11 corresponding to the right half (the first part) of the character O2 (that is, a light-emitting region A4) perform the lighting-up operation, and the light-emitting units 11 corresponding to the right half (the second part) of the character O2 (that is, a non-light-emitting region A5) does not perform the lighting-up operation. Therefore, lateral light filling can be performed on the foreground character O2, so that the portrait features become more stereoscopic. In some embodiments, in the portrait mode with lateral light filling, the light-emitting units 11 corresponding to the eye part may also be controlled not to perform the lighting-up operation through the foregoing manner of detecting the position of eyes. Details are not described herein again.

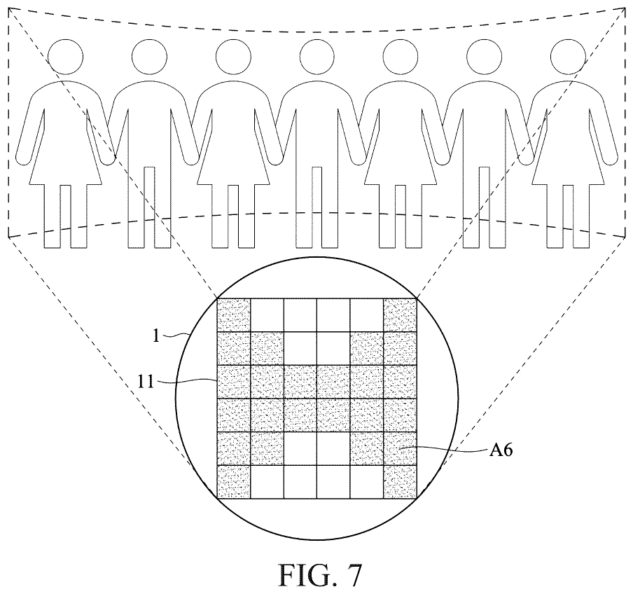

FIG. 7 is a schematic diagram of light filling in a wide-angle mode according to an embodiment of the present invention. Due to the optical limitations of a camera lens, the edges of a wide-angle photo are prone to distortion and vignetting. To resolve this problem, in the wide-angle mode, the array light source element 1 emits light in different regions to fill light for four corner regions. As shown in FIG. 7, some of the light-emitting units 11 (that is, light-emitting region A6) perform the lighting-up operation. The light-emitting region A6 is distributed from a center to four corners of the two-dimensional array, and the brightness increases outward from the center. In other words, the light-emitting unit 11 closer to the corner has higher brightness. It is worth mentioning that, when the optical lens assembly 2 includes the scattering layer 23, the light filling region can be expanded, which is particularly suitable for the wide-angle mode. In some embodiments, in the wide-angle mode, a foreground range may also be determined based on the foregoing scene depth profile DP to correspondingly control the light-emitting units 11 at their respective positions to emit light. Details are not described herein again.

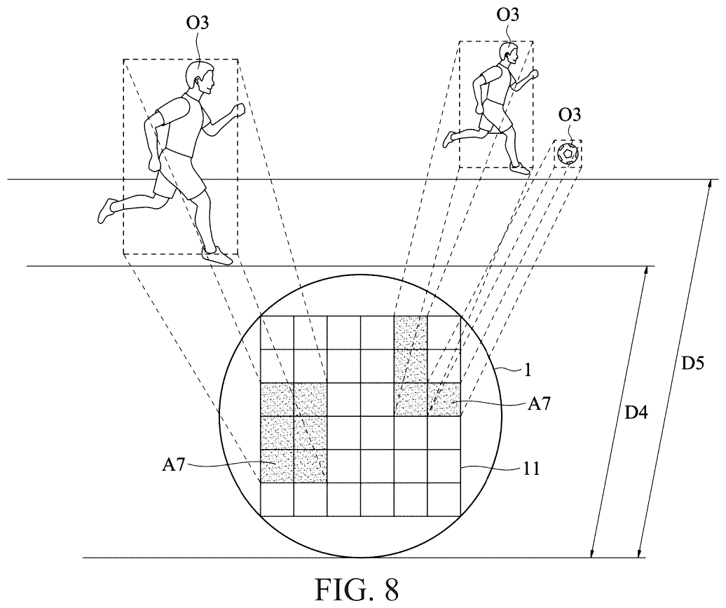

FIG. 8 is a schematic diagram of light filling in a dynamic mode according to an embodiment of the present invention. During photographing of a moving or dynamic scene, to reduce dynamic blurring of an image caused by object movement, light filling may be triggered a plurality of times at high frequency and multiple exposure technologies may be combined to capture a movement trajectory. As described above, dynamic object blocks corresponding to the dynamic object O3 may be found in the scene depth profile DP, to identify the position, shape, and movement trajectory of a corresponding dynamic object O3 in the scene. Therefore, based on the mapping relationship shown in FIG. 2, the computing unit 6 may find the light-emitting units 11 corresponding to the dynamic object blocks (that is, a light-emitting region A7) in the array light source element 1, and enable the light-emitting units 11 in the light-emitting region A7 to perform the lighting-up operation. Herein, the lighting-up operation is slightly different from the foregoing description, and the lighting-up operation is performed for a plurality of times. Therefore, in addition to the brightness and lighting-up time mentioned above, the lighting-up operation also includes the lighting-up frequency. The lighting-up frequency refers to a quantity of lighting-up times of the light-emitting unit 11 per unit time. The lighting-up time refers to the duration of a lighting-up period. By continuously tracking a movement status of the dynamic object blocks corresponding to the dynamic object O3, the computing unit 6 may calculate a movement speed of the dynamic object O3. The computing unit 6 adjusts the lighting-up frequency and brightness of the light-emitting units 11 of the light-emitting region A7 based on the movement speed. Increasing the brightness can shorten exposure time during photographing, and reduce a residual image caused by the movement of the dynamic object O3. When the movement speed of the dynamic object O3 increases, the lighting-up frequency must be increased, to avoid generation of the residual image when multiple images overlap.

It should be noted that although the foregoing descriptions of light filling in the portrait mode, the wide-angle mode, and the dynamic mode focus on partition ranges and the plurality of times of lighting up, in all of these modes, the brightness of the light-emitting unit 11 that performs the lighting-up operation is also adjusted based on a distance corresponding to a foreground object. FIG. 7 is used as an example. A relatively low level of brightness is given to the dynamic object O3 at a relatively short distance (for example, a distance D4), while a relatively high level of brightness is given to the dynamic object O3 at a relatively long distance (for example, a distance D5). The computing unit 6 calculates the brightness of the corresponding light-emitting units 11 based on an integrated ambient light, the movement speed, and the distance of the dynamic object O3.

In some embodiments, as shown in FIG. 1, the detection unit 3 further includes an ambient light detection element 32, configured to detect the ambient light intensity of a scene. The ambient light detection element 32 is coupled to the computing unit 6. The computing unit 6 determines, based on the ambient light intensity detected by the ambient light detection element 32, whether to enable the array light source element 1. When the ambient light intensity is sufficient (for example, higher than a threshold), the array light source element 1 is disabled. When the ambient light intensity is insufficient (for example, lower than a threshold), the array light source element 1 is enabled, and the computing unit 6 performs the foregoing light filling action based on the camera mode.

In some embodiments, the computing unit 6 determines, based on image brightness at a focus position in an image captured by the camera unit 5, whether to enable the array light source element 1. When the image brightness is lower than the threshold, it represents that the ambient light intensity is insufficient, and the array light source element 1 is enabled. Conversely, when the image brightness is greater than the threshold, it represents that the ambient light intensity is sufficient, and the array light source element 1 is disabled.

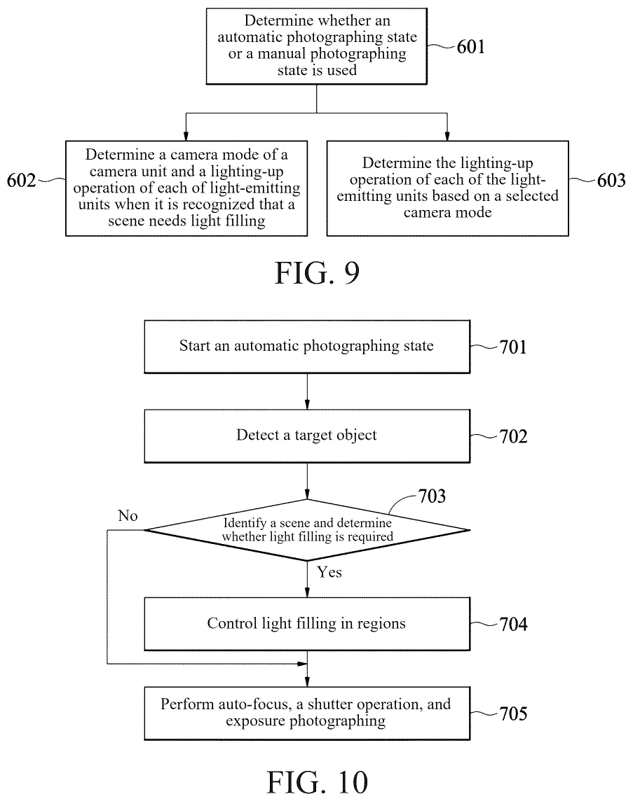

FIG. 9 is a flowchart of a light filling method for a camera apparatus 200 according to an embodiment of the present invention. Step 601. Determine whether the camera apparatus 200 operates in an automatic photographing state or a manual photographing state. If the camera apparatus 200 operates in the automatic photographing state, step 602 is performed. When recognizing, based on a signal fed back by the detection unit 3, that the scene needs light filling, the computing unit 6 determines a camera mode of the camera unit 5 and the lighting-up operation of each of the light-emitting units 11. If the camera apparatus 200 operates in the manual photographing state, step 603 is performed. The computing unit 6 determines the lighting-up operation of each of the light-emitting units 11 based on a selected camera mode.

FIG. 10 is a flowchart of operation of a camera apparatus 200 in an automatic photographing state according to an embodiment of the present invention. After the automatic photographing state starts (step 701), step 702 is performed. Step 702: Based on a scene depth profile detected by a depth sensing element 31, a computing unit 6 may detect a target object, and determine its position, distance, and occupancy range.

Step 703: The computing unit 6 may detect ambient light intensity by using an ambient light detection element 32 or image brightness at a focus position in the image as described above, to determine whether light filling is required. In addition, in some embodiments, based on the image captured by the camera unit 5, the computing unit 6 may recognize the type of scene by using an image recognition technology, to enter a corresponding camera mode. For example, when it is recognized that the image capture picture is a portrait close-up, it will switch to the portrait mode; and when it is recognized that a target in the captured image is moving quickly, it will switch to the dynamic mode. In some embodiments, switching the wide-angle mode or the telephoto mode is determined based on a lens status of the camera unit 5, for example, a currently active lens or a currently used focal length. When a wide-angle lens or a wide-angle focal length is used, it will switch to the wide-angle mode; and when a telephoto lens or a telephoto focal length is used, it will switch to the telephoto mode.

When it is determined in step 703 that light filling is required, step 704 is performed, and the computing unit 6 calculates a light-emitting region in the array light source element 1 and corresponding brightness, lighting-up time, and lighting-up frequency based on the corresponding camera mode, and transmits a corresponding control parameter to the control unit 4. Step 705: The computing unit 6 coordinates a control unit 4 and a camera unit 5, to enable the array light source element 1 to be lighted up in different regions, and enable the camera unit 5 to perform actions such as auto-focus, shutter operation, and image exposure to complete image capture.

When it is determined in step 703 that light filling is not required, step 704 is skipped, and step 705 is performed to capture the image.

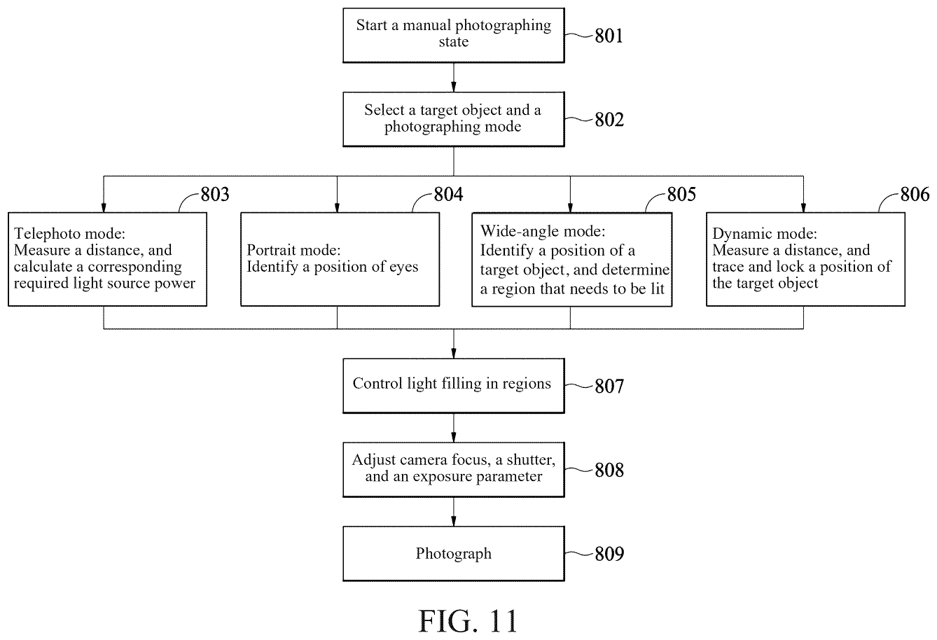

FIG. 11 is a flowchart of operation of a camera apparatus 200 in a manual photographing state according to an embodiment of the present invention. After the manual photographing state starts (step 801), step 802 is performed. Step 802: The camera apparatus 200 receives an operation instruction from a user through an input interface (for example, a touch screen or a physical button) of the camera apparatus, to enter a camera mode selected by the user and determine a focus target selected by the user. Then, corresponding operations are performed based on the selected camera mode (step 803 to step 806). Specific operations of the camera modes are described above, and details are not described herein again. Step 807: The computing unit 6 transmits a corresponding control parameter to the control unit 4 based on light filling requirements in regions corresponding to the camera mode. Step 808: The user adjusts one or more of parameters, such as the camera's focus position, shutter, and exposure through the input interface (a parameter that is not adjusted by the user may be automatically set by calculating an appropriate value by the computing unit 6). Step 809: The computing unit 6 coordinates the control unit 4 with the camera unit 5, and completes image capture based on a light filling setting in step 807 and a camera setting in step 808.

In some embodiments, the control unit 4 and the computing unit 6 are respectively implemented by control circuits such as a central processing unit (CPU), a microprocessor, an application-specific integrated circuit (ASIC), and a system on a chip (SOC). In some embodiments, functions of the control unit 4 and the computing unit 6 are implemented by using a plurality of pieces of program code. The pieces of program code are stored in the memory, and the program code is executed by the control unit 4 and the computing unit 6. In some embodiments, functions of the control unit 4 and the computing unit 6 are implemented by using one or more circuits. The present invention does not limit the functions of the control unit 4 and the computing unit 6 to be implemented by using software or hardware.

According to the camera apparatus and the light filling method described in some embodiments of the present invention, beam deformation can be controlled in a pixilated manner by using the array light source element, to appropriately fill light for an object being photographed in various camera modes, thereby improving the efficiency of light filling.

Certainly, the present invention may further have a plurality of other embodiments. A person skilled in the art may make various corresponding changes and variations according to the present invention without departing from the spirit and essence of the present invention, but these corresponding changes and variations shall all fall within the protection scope of the claims appended to the present invention.

What is claimed is:

1. A camera apparatus, comprising:
an array light source element, comprising a plurality of light-emitting units distributed in a two-dimensional array;
an optical lens assembly, located on a light exit side of the array light source element, to project, to a scene, light beams respectively emitted by the light-emitting units;
a detection unit, comprising a depth sensing element, detecting a scene depth profile for the scene, wherein the scene depth profile is divided into a plurality of depth blocks, and the depth blocks are in a one-to-one correspondence with the light-emitting units;
a control unit, coupled to the array light source element to control a lighting-up operation of each of the light-emitting units, wherein the lighting-up operation comprises brightness and lighting-up time;
a camera unit, capturing an image of the scene in a camera mode; and
a computing unit, coupled to the detection unit, the control unit, and the camera unit, to drive the control unit to selectively perform the lighting-up operation on each of the light-emitting units based on the scene depth profile or the camera mode.

2. The camera apparatus according to claim 1, wherein the optical lens assembly comprises a convex lens, and a light-receiving range of the convex lens covers divergence angles of the light beams respectively emitted by the light-emitting units, to cause each of the light beams to be expanded through the convex lens.

3. The camera apparatus according to claim 2, wherein the optical lens assembly comprises a Fresnel lens, and the convex lens is located between the Fresnel lens and the array light source element, to cause each of the light beams expanded to be collimated, through the Fresnel lens, toward an orientation in the scene corresponding to a corresponding depth block.

4. The camera apparatus according to claim 3, wherein the optical lens assembly comprises a scattering layer, and the Fresnel lens is located between the scattering layer and the convex lens, to cause light homogenization processing to be performed on each of the collimated light beams through the scattering layer.

5. The camera apparatus according to claim 4, wherein the scattering layer comprises a plurality of scattering particles of different particle sizes or an aperiodic microstructure.

6. The camera apparatus according to claim 4, wherein a cross-sectional area of each of the light beams after passing through the scattering layer is greater than a cross-sectional area of each of the light beams before passing through the scattering layer.

7. The camera apparatus according to claim 1, wherein the camera mode is a telephoto mode, some of the depth blocks are respectively long-shot object blocks and correspond to a long-shot object in the scene, and each of the light-emitting units corresponding to the long-shot object block performs the lighting-up operation.

8. The camera apparatus according to claim 1, wherein the camera mode is a portrait mode, some of the depth blocks are respectively human body blocks and correspond to a character in the scene, a first part of the human body blocks corresponds to eyes of the character, a second part of the human body blocks corresponds to remaining parts of the character, each of the light-emitting units of the depth block corresponding to the first part does not perform the lighting-up operation, and each of the light-emitting units of the depth block corresponding to the second part performs the lighting-up operation.

9. The camera apparatus according to claim 1, wherein the camera mode is a portrait mode, some of the depth blocks are respectively human body blocks and correspond to a character in the scene, a first part of the human body blocks corresponds to a first side of the character, a second part of the human body blocks corresponds to a second side of the character, each of the light-emitting units of the depth block corresponding to the first part performs the lighting-up operation, and each of the light-emitting units of the depth block corresponding to the second part does not perform the lighting-up operation.

10. The camera apparatus according to claim 1, wherein the camera mode is a wide-angle mode, some of the light-emitting units perform the lighting-up operation, some light-emitting units are distributed from a center to four corners of the two-dimensional array, and the brightness increases outward from the center.

11. The camera apparatus according to claim 1, wherein the camera mode is a dynamic mode, some of the depth blocks are respectively dynamic object blocks and correspond to a dynamic object in the scene, and each of the light-emitting units corresponding to the dynamic object block performs the lighting-up operation.

12. The camera apparatus according to claim 11, wherein the lighting-up operation comprises a lighting-up frequency, and the light-emitting unit performs the lighting-up operation adjusts the lighting-up frequency and the brightness based on a movement speed of the dynamic object.

13. The camera apparatus according to claim 1, wherein the computing unit determines, based on image brightness at a focus position in an image capture picture of the camera unit, whether to enable the array light source element.

14. The camera apparatus according to claim 1, wherein the detection unit comprises an ambient light detection element, the ambient light detection element is coupled to the computing unit, and the computing unit determines, based on ambient light intensity detected by the ambient light detection element, whether to enable the array light source element.

15. A light filling method for the camera apparatus, comprising:
detecting a scene depth profile and an ambient light intensity for a scene by a detection unit;
determining the camera apparatus operates in an automatic photographing state or a manual photographing state;
in the automatic photographing state, when recognizing the scene needs light filling based on a signal fed back by the detection unit, determining, by a computing unit, the camera mode of the camera unit and a lighting-up operation of an array light source element; and
in the manual photographing state, determining, by the computing unit, the lighting-up operation of the array light source element based on a selected camera mode.
